(19) United States
(12) Patent Application Publication
(10) Pub. No.: US 2013/0132202 A1
(43) Pub. Date: May 23, 2013

(54) AWARDING ACHIEVEMENTS

(71) Applicants: William A. Gordon, Austin, TX (US); Paul A. Weaver, Cedar Park, TX (US)

(72) Inventors: William A. Gordon, Austin, TX (US); Paul A. Weaver, Cedar Park, TX (US)

(73) Assignee: DISNEY ENTERPRISES, INC., Burbank, CA (US)

(21) Appl. No.: 13/303,483

(22) Filed: Nov. 23, 2011

(51) Int. Cl. G06Q 30/02

(52) U.S. Cl. 705/14.58; 705/14.49

(57) ABSTRACT

Techniques are described for awarding achievements unlocked by a user across one or more computer games. Embodiments receive achievement information for a user. The achievement information specifies a first amount of achievement points earned by the user by unlocking achievements across one or more computer games. One or more external offers available for the user based on the received achievement information are then determined. Here, the one or more external offers are separate from the one or more computer games in which the achievements were unlocked. Embodiments then present the determined one or more external offers to the user.

### BACKGROUND

1. Field of the Invention

Embodiments presented in this disclosure generally relate to computer games and, more particularly, to awarding users for achievements unlocked in one or more computer games.

2. Description of the Related Art

A virtual world is a simulated environment in which users may interact with virtual objects and locations of the virtual world. Each user may control a respective avatar through which the user may interact with other users' avatars in the virtual world. An avatar generally provides a graphical representation of an individual within the virtual world environment. Avatars are usually presented to other users as two or three-dimensional graphical representations that resemble a human individual. Frequently, virtual worlds allow multiple users to enter the virtual environment and interact with one another. Virtual worlds are said to provide an immersive environment, as they typically appear similar to the real world and objects tend to follow rules related to gravity, topography, locomotion, physics and kinematics. Of course, virtual worlds can suspend or alter these rules as well as provide other imaginative or fanciful environments. Users typically communicate with one another through their avatars using text messages sent between avatars, real-time voice communication, gestures displayed by avatars, symbols visible in the virtual world, and the like.

Some virtual worlds are described as being persistent. A persistent world provides an immersive environment (e.g., a fantasy setting used as a setting for a role-playing game, or a virtual world complete with land, buildings, towns, and economies) that is generally always available and where events continue to occur regardless of the presence of a given avatar. Thus, unlike more conventional online games or multi-user environments, the virtual world continues to exist and plots and events continue to unfold as users enter (and exit) the virtual world. Virtual environments are presented as images on a display screen and some virtual environment may allow users to record events that occur within the virtual environment.

Many virtual worlds and other computer games feature some form of achievement system in which users may unlock various achievements by performing particular actions within the virtual world. For example, a computer game may include an achievement for winning a particular race within a certain amount of time. If a user of the computer game then wins the race within the specified amount of time, the user would be awarded with the achievement. In certain virtual worlds, a profile may be maintained for the user showing all of the achievements that the user has unlocked thus far. For some gaming platforms, the profile may specify all of the achievements that the user has unlocked across the computer games the user has played for that platform. The user may also share such a profile publicly, so that other users of the gaming platform may see which games the user has played and which achievements the user has unlocked.

### SUMMARY

A method, computer program product and system for presenting offers based on the achievements a user has unlocked across one or more computer games. The method, computer program product and system include receiving achievement information for a user, where the achievement information includes a first amount of achievement points earned by the user, and where the first amount of achievement points were earned by the user from unlocking achievements across one or more computer games. The method, computer program product and system also include determining one or more external offers available for the user based on the received achievement information, wherein the one or more external offers are external from the one or more computer games in which the achievements were unlocked. Additionally, the method, computer program product and system include presenting the determined one or more external offers to the user.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a system configured with an awarding achievements component, according to one embodiment described herein.

FIG. 2 is a diagram illustrating tiered rewards based on achievement points, according to one embodiment described herein.

FIG. 3 is a diagram illustrating tiered rewards based on normalized achievement points, according to one embodiment described herein.

FIG. 4 is a flow diagram illustrating a method for rewarding a user based on unlocked achievement tiers, according to one embodiment described herein.

FIG. 5 is a flow diagram illustrating a method for providing offers to a user based on unlocked achievement tiers, according to one embodiment described herein.

FIG. 6 is a screenshot illustrating an interface for an awarding achievements component, according to one embodiment described herein.

FIG. 7 is a block diagram illustrating a system configured with an awarding achievements component, according to one embodiment described herein.

### DETAILED DESCRIPTION

Although many computer games currently offer some form of unlockable achievement system, there is oftentimes very little that users can do with these achievements once unlocked. Generally, a profile may be maintained across one or more video games that catalogues the achievements the user has unlocked. This profile allows the user to review all the achievements he or she has previously unlocked. Additionally, some gaming systems are configured to allow the user to share the profile with other users. This allows users to see what achievements their friends have unlocked and may also allow a user to show off a particular achievement and/or the total number of achievements the user has unlocked. Some gaming systems may even have a listing of the top users based on the achievements the users have unlocked, e.g., the top 10 users with the most achievements unlocked.

However, beyond collecting the achievements and bragging rights between users based on the achievements the users have unlocked, these gaming systems offer very little that users can do with their unlocked achievements. As a result, many users simply ignore the achievements they unlock while playing these computer games. This leads to game developers devoting time and resources to creating an achievement system that only a fraction of the players will ever use and appreciate.

Embodiments of the invention generally provide techniques for awarding achievements unlocked by a user across one or more computer games. Achievement information is received that specifies a first amount of achievement points earned by the user by unlocking achievements across one or more computer games. Embodiments then determine one or more external offers that are available for the user based on the received achievement information. As used herein, an external offer is an offer that is separate from the one or more computer games in which the achievements were unlocked. For example, one such offer could be a coupon to purchase particular merchandise at a local retailer or an online retailer. As another example, a second such offer could be exclusive merchandise (e.g., a specially designed shirt) given only to players who have unlocked a certain tier of achievements. The determined one or more external offers are then presented to the user.

Advantageously, embodiments of the invention provide incentives for users to play computer games and to unlock achievements across computer games. That is, because embodiments reward users with external offers based on achievements that the users have unlocked, these rewards may encourage the users to play the computer games and to unlock achievements within the computer games to collect offers and prizes. This in turn may encourage users to purchase and play more computer games in order to collect additional achievement-based rewards.

In one embodiment, the user may be presented with internal offers as well. That is, while an external offer is an offer that is separate from the computer games in which the achievements were unlocked, an internal offer is an offer that is integrated into at least one of the computer games. For example, one such internal offer could be a particular car that a user unlocks using achievement points earned across multiple computer games. As another example, a second such internal offer could be a racetrack that the user unlocks using achievement points.

Additionally, embodiments may identify offers for a particular user based on which tiers of achievement points the user has satisfied. For instance, embodiments could be configured to recognize three separate tiers of achievement points for a particular gaming system: a 1,000 point tier, a 15,000 point tier and a 50,000 point tier. Assuming a particular user has unlocked 25,000 achievement points, embodiments could determine that the user has satisfied the first two tiers (i.e., the 1,000 point tier and the 15,000 point tier) but that the user has not yet satisfied the final tier (i.e., the 50,000 point tier). As such, embodiments could identify offers corresponding to the first two tiers and could present these offers to the user. In response to such offers, the user could be allowed to select one reward per tier. In one embodiment, users are allowed to select one reward per tier for a certain window of time. For instance, users could be allowed to select one reward per tier every 6 months. Of course, such an example is without limitation and is provided for exemplary purposes only. Moreover, one of ordinary skill in the art will recognize that a variety of other reward arrangements may be used consistent with the functionalities described herein.

In certain embodiments, exclusive rewards may be offered to users who have unlocked particular achievements or tiers of achievements. For example, an exclusive t-shirt that says “Pro Racer” could be offered to users who have unlocked every single achievement of a particular racing game. In particular embodiments, certain rewards may be offered to a predetermined number of users that are the first to unlock a particular achievement or achievement tier. As an example, the “Pro Racer” t-shirt could be offered only to the first 1,000 users to unlock all the achievements of the racing game. In one embodiment, the user may be given preferential treatment with respective to particular goods or services as an award for unlocking a certain tier of achievement. For example, users who unlock all the achievements within a first computer game could be rewarded with an early release copy of the sequel computer game, allowing them to play the sequel computer game before other members of the public. Advantageously, such rewards encourage users to play the first computer game in order to unlock achievements within the game and may encourage users to purchase the sequel game in order to take advantage of the early release reward.

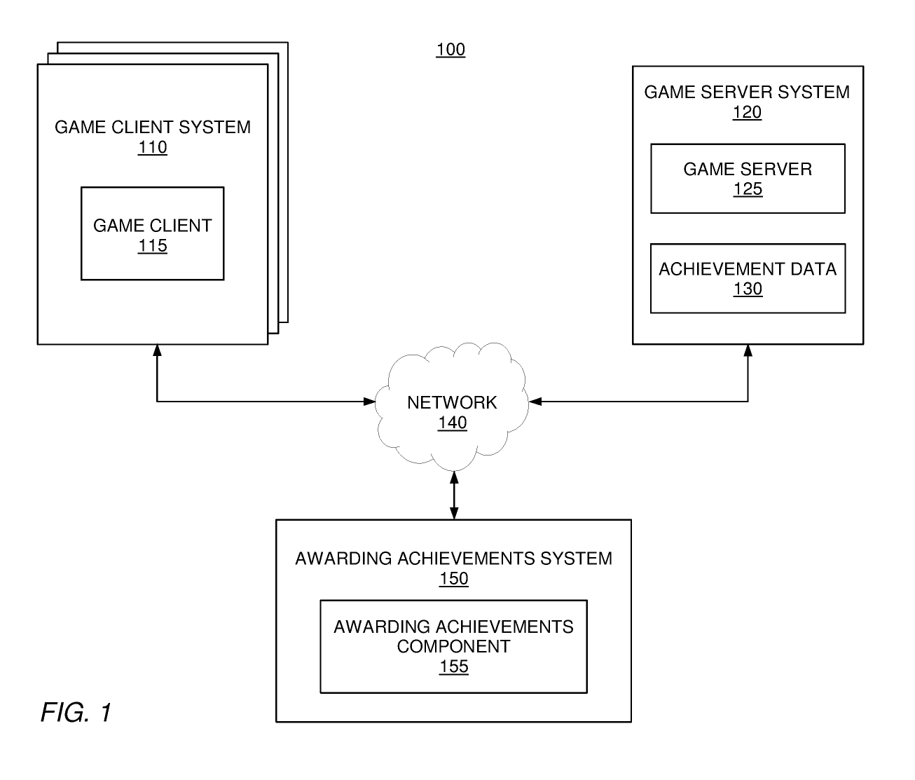

FIG. 1 is a block diagram illustrating a system configured with an awarding achievements component, according to one embodiment described herein. As shown, the system 100 includes a plurality of game client systems 110, a game server system 120 and an awarding achievements system 150, all interconnected via a network 140. The game client system 110 includes a game client 115. Generally, the game client 115 represents any computer game that may be executed on the game client system 110. Although a single game client 115 is shown, it is explicitly contemplated that the game client systems 110 may be configured to run any number of game clients 115. These clients 115 may be stored locally on the game client system 110. In particular embodiments, the game clients 115 are stored on a computer-readable medium that is accessible by the game client system 110.

The game server system 120 includes a game server 125 and achievement data 130. The game server 125 generally represents software that manages user account information for users of the game client 115. For instance, users may provide login and password information through the game client 115. The game client 115 could transmit this credentials information to the game server 125, which could authenticate and/or authorize the user using the credentials information. For example, the user could login to the game server 125 using the game client 115 before the user begins playing the computer game. The game server system 120 could then maintain achievement data 130 as the user plays the computer game. The achievement data 130 generally represents data characterizing achievements each user has unlocked. In one embodiment, the achievement data 130 characterizes the achievements the user has unlocked in a particular computer game. In another embodiment, the achievement data 130 characterizes the achievements the user has unlocked across all computer games played on the game client system 110. As described above, in one embodiment, each unlockable achievement may be associated with a respective number of achievement points. In such an embodiment, the achievement data 130 could specify a total number of achievement points a user has unlocked, which could be computed by calculating the sum of the respective number of achievement points associated with each achievement the user has unlocked.

As shown, the awarding achievements system 150 contains an awarding achievements component 155. The awarding achievements component 155 is generally configured to determine external offers to present to a user based on achievements the user has unlocked across one or more computer games. In one embodiment, the awarding achievements system 150 is a mobile device (e.g., a mobile phone). For example, the awarding achievements component 155 could retrieve the achievement data 130 for the user from the game server system 120 and could determine a number of achievement points the user has unlocked. The awarding achievements component 155 could then identify one or more achievement tiers the user has satisfied by comparing the number of achievement points the user has unlocked with the corresponding amount of achievement points associated with each of the respective tiers.

In one embodiment, the awarding achievements component 155 is configured to provide additional rewards to the user for unlocking achievements in a single game on multiple platforms. For instance, the user could purchase the game for a handheld gaming platform and a console gaming platform. Upon determining that the user has unlocked achievements for the game on both of the gaming platforms, the awarding achievements component 155 could then identify additional rewards to present to the user. Such rewards could include an additional number of achievement points as a reward to the user for purchasing copies of the game for multiple platforms. As another example, the awarding achievements component 155 could reward the user with exclusive rewards that can only be unlocked by users who have purchased copies of the game for multiple platforms. Generally, the rewards may be proportional to the achievements the user has unlocked across the multiple copies of the game. For instance, if the user unlocks an achievement in each game by starting the first level in each game, the awarding achievements component 155 could present the user with a relatively minor award. As another example, if the user completes the entirety of the game on each of the multiple gaming systems, the awarding achievements component 155 could select a relatively large award for the user. Advantageously, doing so rewards the user for purchasing and playing the game, which may in turn motivate users to purchase additional games or additional copies of a particular game for multiple gaming platforms.

The awarding achievements component 155 could then select one or more external offers to present to the user, based on the tiers the user has satisfied. Advantageously, doing so rewards the user for unlocking achievements across the one or more computer games. This may in turn encourage the user to play the computer games and to play additional computer games as well. Additionally, although the awarding achievements component 155 is shown as residing on the awarding achievements system 150, such a depiction is without limitation and is provided for illustrative purposes only. Moreover, it is broadly contemplated that the awarding achievements component 155 could reside on the game client systems 110, the game server system 120, a node in a cloud computing system, a combination of multiple computer systems, or more generally on any computer system capable of performing the functions described herein.

The user could then select one or more of the external offers to be fulfilled by the awarding achievements component 155. For instance, the awarding achievements component 155 could fulfill a selected offer for a particular t-shirt by generating an order on behalf of the user requesting the t-shirt be mailed to the user. As another example, the awarding achievements component 155 could transmit an electronic barcode to the user that could be used to fulfill the offer. For instance, if the external offer is $10 off a particular Blu-ray movie, the user could have a store scan the electronic bar code (e.g., from the display of the user's mobile device) in order to receive the discount when purchasing the Blu-ray movie.

In one embodiment, the awarding achievements component 155 is configured to associate the selected offer with a virtual e-wallet account of the user. That is, the selected offer could be directly integrated into the user's virtual e-wallet account such that the offer is automatically applied the next time the user makes a qualifying purchase using the virtual e-wallet account. For example, one such external offer could be 20% off the user's next order at a particular website. The awarding achievements component 155 could directly integrate such an offer into the user's virtual e-wallet account such that the next time the user places an order at the particular website using the virtual e-wallet account the 20% discount could be automatically applied. In a particular embodiment, the awarding achievements component 155 could be configured to transmit a promo code to the user to fulfill the discount offer. In such an embodiment, the user could then enter the promo code at the website in order to receive the discount when making a purchase.

In a particular embodiment, the game client system 110 is configured to identify achievement-related rewards available within a particular distance from the game client system 110. For instance, the game client system 110 could be configured to receive global positioning system (“GPS”) signals for use in determining the system's 110 current physical location. The awarding achievements component 115 could then identify one or more nearby offers available for the user, based on achievement data for the user and the determined current location of the client system 110. For example, the awarding achievements component 155 could determine that a video game retailer nearby is offering $10 off the purchase of a new computer game for users who have unlocked the 25,000 achievement point tier for a particular gaming system. If the awarding achievements component 155 determines that the user has unlocked this tier of achievement points, the awarding achievements component 155 could notify the user of the nearby offer of a $10 off coupon.

Additionally, the awarding achievements component 155 could be configured to notify users who have unlocked a certain tier of achievements of nearby locations where they can receive preferential treatment based on their achievement status. For instance, users who have unlocked a certain tier of achievements could receive priority status when waiting in lines for a certain ride at a theme park. Advantageously, doing this informs users of nearby locations where the users can receive preferential treatment based on their unlocked achievements, which may be preferable to some users. Additionally, this may encourage users to purchase and play computer games more frequently, so that the users can unlock more achievements and receive additional rewards. Of note, it is broadly contemplated that the awarding achievements component 155 may be configured to determine awards to present to the user based on any determinable physical location of the user, including both terrestrial and extraterrestrial physical locations.

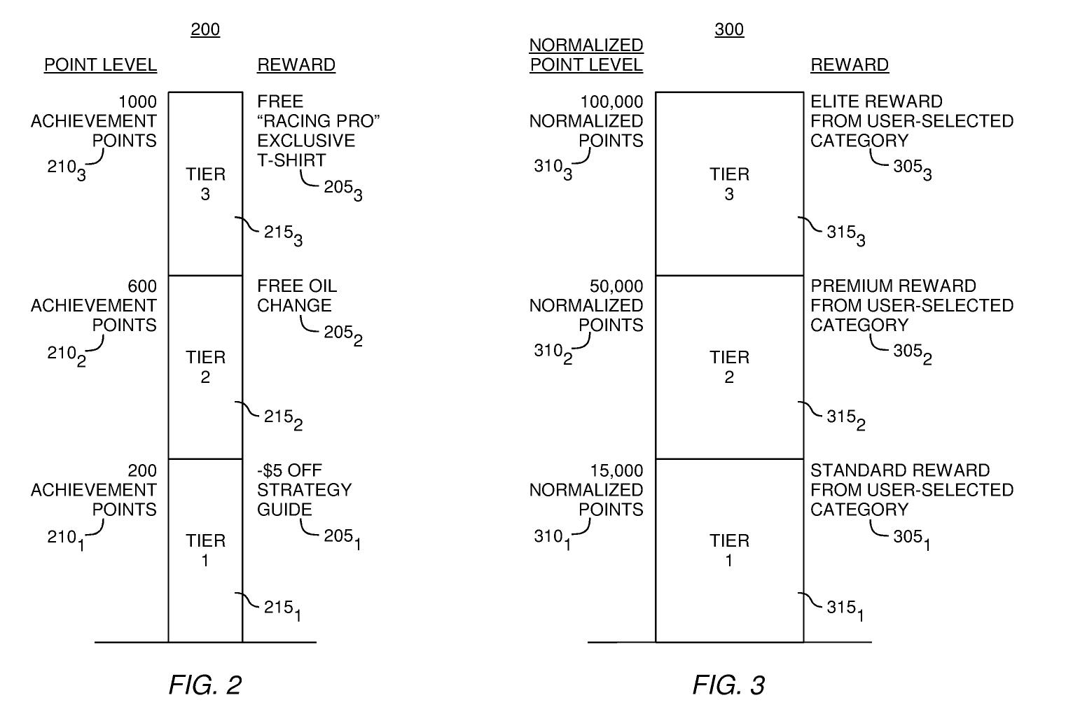

FIG. 2 is a diagram illustrating tiered rewards based on achievement points, according to one embodiment described herein. For the discussion of FIG. 2, assume that the depicted achievement tiers correspond to a gaming system where each computer game has a maximum of 1,000 achievement points, and that FIG. 2 pertains to tiers of achievement points for a single computer game. As shown, the diagram 200 depicts three tiers 215 of achievements for a racing computer game, with each tier 215 having a corresponding amount of achievement points 210 and an associated reward 205. For example, the first tier 215₁ corresponds to the amount 210₁ of 200 achievement points and the reward 205₁ of a $5 discount for a strategy guide. As another example, the second tier 215₂ corresponds to the amount 210₂ of 600 achievement points and the reward 205₂ of a coupon for a free oil change. The awarding achievements component 155 could retrieve achievement data for a user and determine which tiers the user has satisfied. For instance, the awarding achievements component 155 could compare the number of achievement points unlocked by the user in the racing game with the point level 210 corresponding to each of the tiers 215. As an example, if the awarding achievements component 155 determines the user has earned 850 achievement points, the awarding achievements component 155 could determine the user has satisfied tiers 215₁ and 215₂, but that the user has not yet satisfied the third tier 215₃.

Upon determining which tiers 215 the user has satisfied for the racing game, the awarding achievements component 155 could determine one or more offers to present the user with. Thus, in the current example, since the user has satisfied tiers 215₁ and 215₂, the awarding achievements component 155 could present the user with the offers of $5 off a strategy guide and a coupon for a free oil change. However, since the user has not yet earned enough achievement points to satisfy the third tier 215₃, the awarding achievements component 155 would not present the user with the offer of an exclusive “Racing Pro” t-shirt. Advantageously, doing so rewards users for playing the racing game and encourages users to play the racing game to the fullest extent in order to unlock all of the achievements in the game.

As discussed above, embodiments of the present invention may also be configured to reward users for unlocking achievements across a multitude of computer games. For instance, FIG. 3 shows a diagram illustrating tiered rewards based on normalized achievement points across all computer games for multiple gaming systems, according to one embodiment described herein. As shown, the diagram 300 depicts three tiers 315 of achievements across all the computer games for a particular gaming system, with each tier 315 having a corresponding normalized amount of achievement points 310 and an associated reward 305. In the depicted embodiment, since each of the gaming systems may use a different achievement point system, the tiers 315 are associated with a normalized achievement point level 310. For example, a first gaming console could use an achievement point system where each game has a maximum of 1,000 achievement points, while a second gaming console could use an achievement point system where each game has a maximum of only 100 achievement points. In order to offer achievement-based rewards across both the first and second gaming consoles, the awarding achievements component 155 could normalize the achievement points from each console so that players can earn a maximum of 1,000 achievement points per game. Thus, in the current example, the awarding achievements component 155 could multiply achievement points earned on the second gaming console by 10, in order to normalize the achievement points to the 1,000 points per game model.

Thus, in the depicted example, if the awarding achievements component 155 determines that the user has earned 25,000 normalized achievement points, the awarding achievements component 155 could determine that the user has satisfied tier 1 315₁, but that the user has not yet satisfied tiers 2 315₂ or tier 3 315₃. Thus, the awarding achievements component 155 could present the user with a standard-level reward 305₁. That is, rather than having fixed rewards associated with each tier 315, the awarding achievements component 155 could select a reward that the user will likely be interested in from a category of rewards. Additionally, the rewards 305 relate to categories that escalate in value, such that the elite category of rewards 305₃ would contain more valuable offers than the premium category of rewards 305₂, which in turn would contain more valuable offers than the standard category of rewards 305₁. Thus, the value of the rewards 305 increase in the depicted embodiment as the level 310 of normalized achievement points increases.

The awarding achievements component 155 could then select an offer from within a category relating to the interests of the user. For example, an exemplary user could indicate that he is interested in sports cars and football. Upon determining that the user has satisfied at least one tier 315 of rewards, the awarding achievements component 155 could present the user with an offer relating to the categories the user indicated he is interested in. Thus, continuing the example, the awarding achievements component 155 could present the user with an offer for a standard category reward 305₁ that relates to sports cars and/or football. Advantageously, doing so helps to ensure that the user will be rewarded with offers that are relevant to the interests of the user and that the user will appreciate.

In a particular embodiment, the awarding achievements component 155 may determine the categories the user is interested in by monitoring the actions of the user over a period of time. For instance, the awarding achievements component 155 could monitor, without limitation, games the user plays, videos the user watches using the gaming system, websites the user interacts with and so on to determine the general interests of the user. The awarding achievements component 155 could then determine one or more categories that the user is interested in, based on the monitored actions of the user. For example, if the user frequently plays racing games and browses forums relating to performance cars, the awarding achievements component 155 could determine that the user is interested in the category of sports cars. The awarding achievements component 155 could then present car-related offers to the user as a reward for unlocking a particular tier of achievement points. Of course, these examples are provided for illustrative purposes only and without limitation. Moreover, one of ordinary skill in the art will recognize that any number of categories and tiers of rewards may be used consistent with the embodiments described herein.

Additionally, although the present example relates to normalized achievement points across multiple computer games for multiple gaming systems, particular embodiments may be configured to normalize points across multiple computer games for a single gaming system. Such an embodiment may be appropriate, for instance, for a gaming system that does not mandate an equal number of achievement points per computer game. For example, if a particular gaming system allows the game developers to dictate the number of achievement points available for a particular game, the awarding achievements component 155 could normalize the achievement points earned in each game, so as to ensure that each game is given equal weight when rewarding the user based on the achievements unlocked by the user.

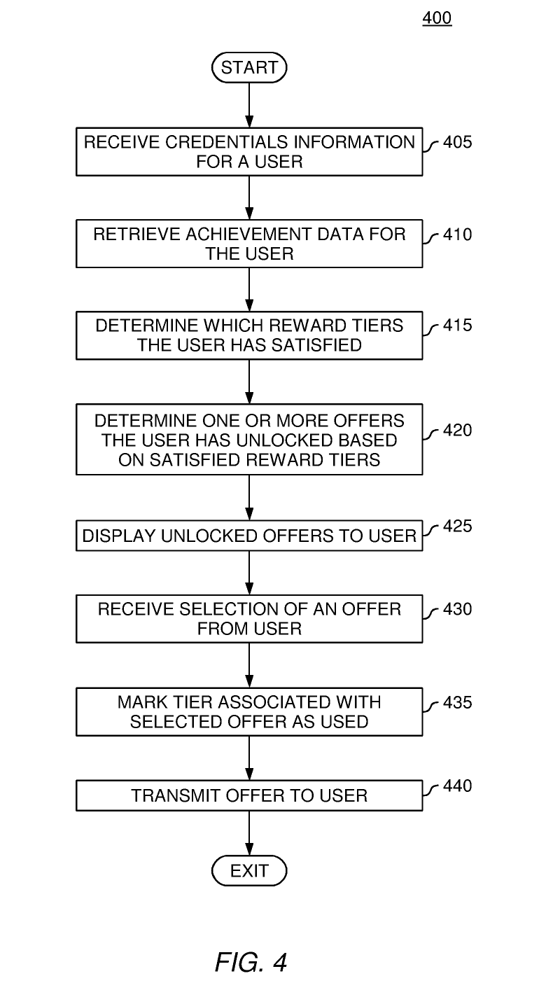

FIG. 4 is a flow diagram illustrating a method for rewarding a user based on unlocked achievement tiers, according to one embodiment described herein. As shown, the method 400 begins at step 405, where the awarding achievements component 155 receives credential information for accessing achievement information for a user. For instance, the credential information could specify an account name for the user that could be used to access publicly available achievement information for the user. In one embodiment, the credential information includes an account name and a password for the user. In such an embodiment, the awarding achievements component 155 could use the account name and password to access an account for the user on a gaming service. Examples of such a gaming service include Xbox LIVE® and the PlayStation® Network.

Upon receiving the credentials information, the awarding achievements component 155 retrieves the achievement data for the user (step 410). Once the achievement data is retrieved, the awarding achievements component 155 determines which tiers of rewards the user has satisfied based on the retrieved achievement data (step 415). As discussed above, the awarding achievements component 155 may be configured to recognize several tiers of achievement points, with each tier associated with a respective number of required achievement points. In such an embodiment, a user may be said to satisfy a particular tier of achievement points if the user has unlocked an amount of achievement points greater than or equal to the required number achievement points associated with the particular tier. Additionally, as discussed above, the awarding achievements component 155 may also be configured to recognize tiers of normalized achievement points. In such an embodiment, the awarding achievements component 155 may normalize the amount of achievement points the user has unlocked and use the normalized achievement points to determine which tiers the user has satisfied.

Once the awarding achievements component 155 determines which reward tiers the user has satisfied, the awarding achievements component 155 determines one or more offers to present to the user based on which tiers the user has satisfied (step 420). As previously discussed, in one embodiment the awarding achievements component 155 selects the one or more offers from categories the user has indicated he is interested in. In a particular embodiment, the awarding achievements component 155 monitors actions of the user in order to determine the categories the user is interested in. The determined offers are then displayed to the user (step 425).

Subsequently, the awarding achievements component 155 receives a selection of one of the offers from the user (step 430). The awarding achievements component 155 then marks the tier corresponding to the selected offer as used (step 435) and transmits the selected offer to the user (step 440). That is, in this embodiment, the user is entitled to receive only one offer per tier of rewards. As such, once the user has selected one of the offers, the awarding achievements component 155 marks the corresponding tier as satisfied. Once the selected offer is transmitted, the method 400 ends.

In one embodiment, the awarding achievements component 155 is configured to determine the one or more offers to present to the user further based on a geographic location of the user. For instance, the awarding achievements component 155 could be configured to select particular offers only for users within a specific geographic area. If a particular user has then unlocked the tier of achievement points associated with these offers and if the particular user is also currently within the specific geographic area associated with these offers, the awarding achievements component 155 could selected one of these offers to present to the user. For example, one such offer could be access to the “FastPass” line for a particular ride at a theme park. In such an example, the awarding achievements component 155 could be configured to only present this offer to users that are currently located within a predefined geographic distance from the theme park (e.g., as determined by a global positioning system (“GPS”) component within a user device equipped with the awarding achievements component 155).

Additionally, the awarding achievements component 155 could be configured to associate particular categories of offers with corresponding geographic locations. For example, the awarding achievements component 155 could be configured to automatically present offers from an “Automotive” offer category upon determining that a user is geographically located within an area having a predefined association with automobiles. Continuing this example, if a first user then accesses the awarding achievements component 155 on a mobile device from a race track, the awarding achievements component 155 could select an offer from the “Automotive” category of offers and for which the user has unlocked the required tier of rewards to present to the user. Advantageously, doing so helps to present users with relevant offers based on the users' current geographic locations.

In one embodiment, the awarding achievements component 155 is configured to consider other location information for the user in select which offers to present to the user. For instance, the awarding achievements component 155 could select the offers based on geographic attributes such as the user's current heading, velocity and course. Here, the user's heading is defined as the direction in which the user is pointing the system equipped with the awarding achievements component 155. For instance, a user could possess a mobile phone device equipped with the awarding achievements component 155. In such an example, the heading of the mobile phone device would refer to current direction in which the user is pointing the device. The user's course refers to the direction in which the user is currently travelling and the velocity refers to the rate at which the user is travelling. Of note, the user's course is distinct from and may not always be the same as the user's heading. For example, while a user could be travelling in a first direction, the user could be pointing the mobile device in a second, different direction.

The awarding achievements component 155 could be configured to select one or more offers to present to the user based on these other geographic attributes. For instance, the awarding achievements component 155 could determine that although the user's current geographic location is on a particular highway, the user's course and velocity indicate that the user is heading towards and shopping mall and will arrive at the shopping mall in a matter of minutes. Upon determining this, the awarding achievements component 155 could select one or more offers associated with the shopping mall to present to the user. As another example, the awarding achievements component 155 could determine that a plurality of offers is associated with the user's current location. In order to select one of the plurality of offers, the awarding achievements component 155 could determine the user's current heading (i.e., based on the direction the user's mobile device is facing) and could select one or more of the plurality of offers based on the determined heading of the user. That is, since the user's heading may indicate the direction in which the user is currently facing, the awarding achievements component 155 could use the user's heading to determine which of the plurality of offers are associated with a location in the direction the user is currently facing. Of course, these examples are provided without limitation and for illustrative purposes only. Moreover, it is broadly contemplated that any geographic attribute for the user may be used in selecting offers to present to the user in accordance with embodiments of the present invention described herein.

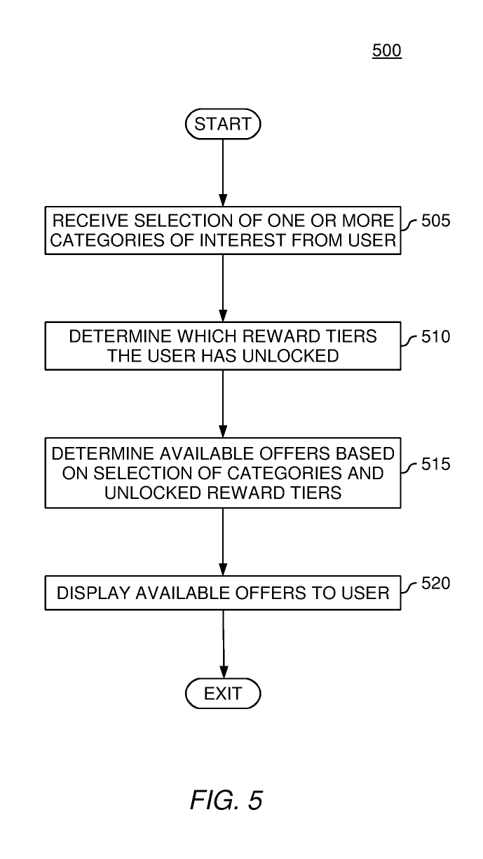

FIG. 5 is a flow diagram illustrating a method for providing offers to a user based on unlocked achievement tiers, according to one embodiment described herein. As shown, the method 500 begins at step 505, where the awarding achievements component 155 receives a selection of one or more categories of interest from the user. For example, the user could indicate the he is interested in the categories of cars and sports. Such information could be stored, for instance, in a user profile that the awarding achievements component 155 maintains for the user. As another example, such interest information could be stored in a user profile maintained for the user on one or more of the gaming systems on which the user has unlocked achievements.

The awarding achievements component 155 then determines which tiers of rewards the user has unlocked based on achievement data for the user (step 510). Generally, each of the tiers is associated with a respective number of achievement points. The awarding achievements component 155 may determine this by comparing the achievement data for the user with the number of achievement points associated with each of the tiers. As discussed above, such achievement data generally reflects the achievements the user has unlocked. In one embodiment, the achievement data represents a list of all the achievements the user has unlocked. In such an embodiment, the awarding achievements component 155 may analyze the list of achievements to calculate a number of achievement points earned by the user. In another embodiment, the achievement data represents a total number of achievements unlocked by the user. In yet another embodiment, the achievement data represents a number of points earned by the user, where each unlocked achievement is assigned a respective number of points. Additionally, the awarding achievements component 155 may normalize the achievement points the user has unlocked before determining which tiers of rewards the user has unlocked.

Once the awarding achievements component 155 determines which tiers of rewards the user has unlocked, the awarding achievements component 155 determines one or more available offers for the user, based on the selected categories and the unlocked reward tiers (step 515). The awarding achievements component 155 then displays the determined offers to the user (step 520), and the method 500 ends.

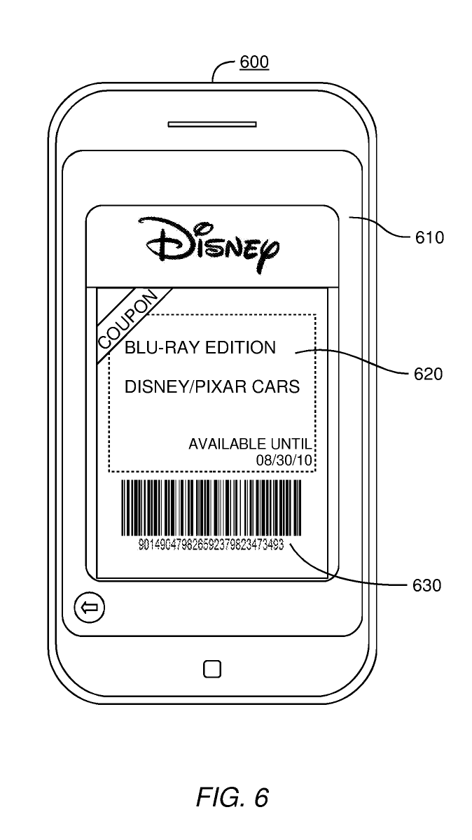

FIG. 6 is a screenshot illustrating an interface for an awarding achievements component, according to one embodiment described herein. As shown, the screenshot depicts an offer transmitted to a user via the display 610 of a mobile device 600. In the depicted embodiment, the offer includes a textual description 620 and a Universal Product Code (“UPC”) barcode 630. Here, the offer received by the user is a coupon for purchasing the Blu-Ray edition of the movie “Cars”. Thus, in the depicted embodiment, the awarding achievements component 155 has determined that a user has satisfied at least one tier of rewards and has selected the coupon for the Blu-Ray version of “Cars” as the offer to present to the user. Advantageously, by transmitting the barcode 630 to the user via the mobile device 600, the awarding achievements component 155 is able to immediately present the achievement-based reward to the user.

Such a system may be preferable, for instance, when the awarding achievements component 155 is identifying rewards that are in proximity to the current location of the user. For instance, particular embodiments may be configured to receive GPS signals and to use these signals to determine the current location of the user. The awarding achievements component 155 may then identify nearby rewards to present to the user, based on the current position of the user and achievements unlocked by the user. Thus, in the context of the current example, the awarding achievements component 155 could determine that the user is currently inside a video store (e.g., using the GPS capabilities of a mobile device equipped with an awarding achievements component 155) and select the depicted coupon for a Blu-Ray movie to present to the user. Doing so provides the user with immediate reward offers that are relevant to the user's current location.

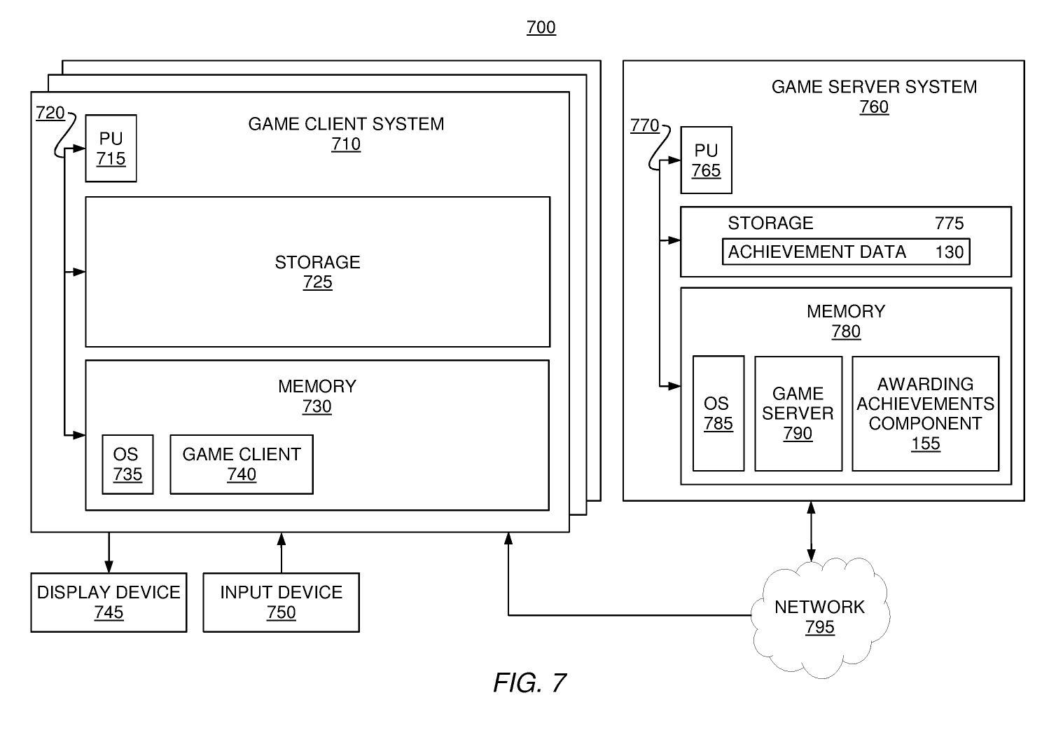

FIG. 7 is a block diagram illustrating a system configured with an awarding achievements component, according to one embodiment described herein. As shown, the system 700 includes a plurality of game client systems 710 and a server system 760, communicatively coupled via a network 795. In one embodiment, the game client systems 710 may include existing computer systems, e.g., desktop computers, server computers, laptop computers, tablet computers, gaming consoles, hand-held gaming devices and the like. The game client systems 710 illustrated in FIG. 7, however, are merely examples of computer systems in which embodiments of the present invention may be used. Embodiments of the present invention may be implemented differently, regardless of whether the computer systems are complex multi-user computing systems, such as a cluster of individual computers connected by a high-speed network, single-user workstations, or network appliances lacking non-volatile storage. Moreover, it is explicitly contemplated that embodiments of the invention may be implemented using any device or computer system capable of performing the functions described herein.

As shown, each client system 710 includes, without limitation, a processor 715, which obtains instructions and data via a bus 720 from a memory 730 and storage 725. Processor 715 is a programmable logic device that performs instruction, logic, and mathematical processing, and may be representative of one or more CPUs. Storage 725 is representative of hard-disk drives, flash memory devices, optical media and the like. Generally, the storage 725 stores application programs and data for use by the client system 710. The client systems 710 are operably connected to the network 795, e.g., via network interfaces.

The memory 730 is any memory sufficiently large to hold the necessary programs and data structures. Memory 730 could be one or a combination of memory devices, including Random Access Memory, nonvolatile or backup memory (e.g., programmable or Flash memories, read-only memories, etc.). In addition, memory 730 and storage 725 may be considered to include memory physically located elsewhere; for example, on another computer coupled to the client system 710 via bus 720. The memory 730 includes a game client 740 and an operating system (“OS”) 735. Operating system 735 is software used for managing the operation of the game client system 710. Examples of OS 735 include UNIX, versions of the Microsoft Windows® operating system and distributions of the Linux® operating system. Additional examples of operating system 735 include custom operating systems for gaming consoles, including the custom operating systems for systems such as the Microsoft Xbox 360®, Nintendo Wii® and Sony PlayStation® 3.

Additionally, the client systems 710 each are coupled to display devices 745 and input devices 750. The display devices 745 may include output devices such as monitors, touch screen displays, and so on. For instance, the display devices 745 may include a display device used to visually depict a virtual environment. As an example, the display 745 may provide a touch sensitive surface allowing the user to select different locations within the virtual environment and control the movement of an avatar within the virtual environment. The input devices 750 represent a wide variety of input devices, including keyboards, mice, controllers, and so on. Furthermore, the input devices 750 may include a set of buttons, switches or other physical device mechanisms for controlling the client system 710. For example, the input devices 750 could include a set of directional buttons used to navigate an avatar through a virtual environment presented on the display 745.

As shown, the game server system 760 includes, without limitation, a processor 765, which obtains instructions and data via a bus 770 from a memory 780 and storage 775. Processor 765 is a programmable logic device that performs instruction, logic, and mathematical processing, and may be representative of one or more CPUs. Storage 775 is representative of hard-disk drives, flash memory devices, optical media and the like. Generally, the storage 775 stores application programs and data for use by the server system 760. As shown, storage 775 contains achievement data 130. The achievement data 130 generally describes the achievements that users have unlocked across one or more games. The server system 760 is operably connected to the network 795, e.g., via a network interface.

The memory 780 is any memory sufficiently large to hold the necessary programs and data structures. Memory 780 could be one or a combination of memory devices, including Random Access Memory, nonvolatile or backup memory (e.g., programmable or Flash memories, read-only memories, etc.). In addition, memory 780 and storage 775 may be considered to include memory physically located elsewhere; for example, on another computer coupled to the server system 760 via bus 770. The memory 780 includes an OS 785, a game server 790 and an awarding achievements component 155. Operating system 785 is software used for managing the operation of the game server system 760. Examples of OS 785 include UNIX, versions of the Microsoft Windows® operating system and distributions of the Linux® operating system. Additional examples of operating system 785 include custom operating systems for gaming consoles, including the custom operating systems for systems such as the Microsoft Xbox 360®, Nintendo Wii® and Sony PlayStation® 3.

As discussed above, a user may unlock one or more achievements within a computer game (represented by the game client 740). The game server 790 may maintain this information as part of the achievement data 130. The awarding achievements component 155 may use this achievement data 130 to determine one or more offers for the user. More specifically, the awarding achievements component 155 may determine a number of achievement points unlocked by the user and may identify one or more tiers of rewards that the user has satisfied based on the determined number of achievement points. The awarding achievements component 155 may then present one or more external offers associated with these unlocked tiers to the user.

In the preceding, reference is made to embodiments of the invention. However, the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the preceding aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., a game server 150 configured with an avatar positioning component 160) or related data available in the cloud. For example, the avatar positioning component 160 could execute on a computing system in the cloud and receive a request from a user to move to user's avatar to a specified location (e.g., from a game client 120 associated with the user). In such a case, the avatar positioning component 160 could determine a zone that encompasses the specified location and could select a second location within the zone at which to display the user's avatar to other users in the virtual world. Doing so prevents users from creating formations of avatars within the virtual world that have the appearance of offensive content when viewed by another user accessing the virtual world from a computing system attached to a network connected to the cloud (e.g., the Internet).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special-purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method, comprising:
receiving achievement information for a user, wherein the achievement information includes a first amount of achievement points earned by the user, wherein the first amount of achievement points were earned by the user from unlocking achievements across one or more computer games;
determining one or more external offers available for the user based on the received achievement information, wherein the one or more external offers are external from the one or more computer games in which the achievements were unlocked; and
presenting the determined one or more external offers.

2. The method of claim 1, further comprising:
receiving a selection of one of the presented external offers from the user; and
fulfilling the selected external offer for the user.

3. The method of claim 2, wherein fulfilling the selected external offer comprises:
transmitting a bar code corresponding to the selected external offer.

4. The method of claim 2, wherein fulfilling the selected external offer comprises:
receiving address information associated with the user; and
generating an order for one or more items using the received address information.

5. The method of claim 1, wherein receiving achievement information for a user further comprises:
identifying one or more achievements the user has unlocked across the one or more computer games;
for each of the identified one or more achievements, determining an achievement point value corresponding to the achievement;
determining the first amount of achievement points by calculating a sum of the determined achievement point values.

6. The method of claim 1, further comprising:
receiving credentials information associated with the user; and
transmitting a request for the achievement information for the user.

7. The method of claim 1, wherein the first amount of achievement points were earned using a first gaming platform, and further comprising:
receiving additional achievement information for the user, wherein the additional achievement information includes a second amount of achievement points earned by the user on a second gaming platform; and
normalizing the first amount of achievement points and the second amount of achievement points to produce a normalized total amount of achievement points,
wherein determining one or more external offers available for the user is further based on the normalized total amount of achievement points.

8. The method of claim 1, further comprising:
determining one or more achievement tiers the user has unlocked based on the first amount of achievement points earned by the user, wherein each achievement tier corresponds to a respective number of achievement points, and
wherein determining one or more external offers available for the user is further based on the determined one or more achievement tiers.

9. The method of claim 1, further comprising:
receiving a current physical location for the user, and
wherein determining one or more external offers available for the user is further based upon the received current physical location of the user.

10. The method of claim 1, further comprising:
receiving a selection of one or more categories that the user has expressed interest in, and
wherein determining one or more external offers available for the user is further based on the selected one or more categories.

11. A computer program product, comprising:
a computer-readable storage medium containing a program that, when executed by operation of one or more processors, performs an operation comprising:
computer-readable program code to receive achievement information for a user, wherein the achievement information includes a first amount of achievement points earned by the user, wherein the first amount of achievement points were earned by the user from unlocking achievements across one or more computer games;
computer-readable program code to determine one or more external offers available for the user based on the received achievement information, wherein the one or more external offers are external from the one or more computer games in which the achievements were unlocked; and
computer-readable program code to present the determined one or more external offers.

12. The computer program product of claim 11, the operation further comprising:
computer-readable program code to receive a selection of one of the presented external offers from the user; and
computer-readable program code to fulfill the selected external offer for the user.

13. The computer program product of claim 12, wherein fulfilling the selected external offer comprises:
computer-readable program code to transmit a bar code corresponding to the selected external offer.

14. The computer program product of claim 12, wherein fulfilling the selected external offer comprises:
computer-readable program code to receive address information associated with the user; and
computer-readable program code to generate an order for one or more items using the received address information.

15. The computer program product of claim 11, wherein receiving achievement information for a user further comprises:
computer-readable program code to identify one or more achievements the user has unlocked across the one or more computer games;
computer-readable program code to, for each of the identified one or more achievements, determine an achievement point value corresponding to the achievement;
computer-readable program code to determine the first amount of achievement points by calculating a sum of the determined achievement point values.

16. The computer program product of claim 11, the operation further comprising:
computer-readable program code to receive credentials information associated with the user; and
computer-readable program code to transmit a request for the achievement information for the user

17. The computer program product of claim 11, wherein the first amount of achievement points were earned using a first gaming platform, and the operation further comprising:
computer-readable program code to receive additional achievement information for the user, wherein the additional achievement information includes a second amount of achievement points earned by the user on a second gaming platform; and
computer-readable program code to normalize the first amount of achievement points and the second amount of achievement points to produce a normalized total amount of achievement points,
wherein the computer-readable program code to determine one or more external offers available for the user is further based on the normalized total amount of achievement points.

18. The computer program product of claim 11, the operation further comprising:
computer-readable program code to determine one or more achievement tiers the user has unlocked based on the first amount of achievement points earned by the user, wherein each achievement tier corresponds to a respective number of achievement points, and
wherein the computer-readable program code to determine one or more external offers available for the user is further based on the determined one or more achievement tiers.

19. The computer program product of claim 11, the operation further comprising:
computer-readable program code to receive a current physical location for the user, and
wherein the computer-readable program code to determine one or more external offers available for the user is further based upon the received current physical location of the user.

20. The computer program product of claim 11, the operation further comprising:
computer-readable program code to receive a selection of one or more categories that the user has expressed interest in, and
wherein the computer-readable program code to determine one or more external offers available for the user is further based on the selected one or more categories.

21. A system, comprising:
a processor; and
a memory containing a program that, when executed by the processor, performs an operation comprising:
receiving achievement information for a user, wherein the achievement information includes a first amount of achievement points earned by the user, wherein the first amount of achievement points were earned by the user from unlocking achievements across one or more computer games;
determining one or more external offers available for the user based on the received achievement information, wherein the one or more external offers are external from the one or more computer games in which the achievements were unlocked; and
presenting the determined one or more external offers.

22. The system of claim 21, the operation further comprising:
receiving a selection of one of the presented external offers from the user; and
fulfilling the selected external offer for the user.

23. The system of claim 22, wherein fulfilling the selected external offer comprises:
transmitting a bar code corresponding to the selected external offer.

24. The system of claim 22, wherein fulfilling the selected external offer comprises:
receiving address information associated with the user; and
generating an order for one or more items using the received address information.

25. The system of claim 21, wherein receiving achievement information for a user further comprises:
identifying one or more achievements the user has unlocked across the one or more computer games;
for each of the identified one or more achievements, determining an achievement point value corresponding to the achievement;
determining the first amount of achievement points by calculating a sum of the determined achievement point values.

26. The system of claim 21, the operation further comprising:
receiving credentials information associated with the user; and
transmitting a request for the achievement information for the user

27. The system of claim 21, wherein the first amount of achievement points were earned using a first gaming platform, and the operation further comprising:
receiving additional achievement information for the user, wherein the additional achievement information includes a second amount of achievement points earned by the user on a second gaming platform; and
normalizing the first amount of achievement points and the second amount of achievement points to produce a normalized total amount of achievement points,
wherein determining one or more external offers available for the user is further based on the normalized total amount of achievement points.

28. The system of claim 21, the operation further comprising:
determining one or more achievement tiers the user has unlocked based on the first amount of achievement points earned by the user, wherein each achievement tier corresponds to a respective number of achievement points, and
wherein determining one or more external offers available for the user is further based on the determined one or more achievement tiers.

29. The system of claim 21, the operation further comprising:
receiving a current physical location for the user, and
wherein determining one or more external offers available for the user is further based upon the received current physical location of the user.

30. The system of claim 21, the operation further comprising:
receiving a selection of one or more categories that the user has expressed interest in, and
wherein determining one or more external offers available for the user is further based on the selected one or more categories.
